(19) United States
(12) Patent Application Publication
(10) Pub. No.: US 2009/0276839 A1
(43) Pub. Date: Nov. 5, 2009

(54) IDENTITY COLLECTION, VERIFICATION AND SECURITY ACCESS CONTROL SYSTEM

(75) Inventor: Andreas Peneder, Sebastopol, CA (US)

Correspondence Address: SILVERSKY GROUP LLC, 5422 LONGLEY LANE, SUITE B, RENO, NV, 89511, US

(73) Assignee: FORTKNOCK PROTECTION LLC, Sebastopol, CA (US)

(21) Appl. No.: 12/433,643

(22) Filed: Apr. 30, 2009

Related U.S. Application Data
(60) Provisional application No. 61/126,327, filed on May 2, 2008.

(51) Int. Cl. H04L 29/06; G06F 21/00

(52) U.S. Cl. 726/8

(57) ABSTRACT

A system for collecting personally identifying information from individuals and using that information in verifying their identity and permitting their access to one or more secure systems via a single login authentication system. Based on a series of questions (opinion-based), a database of answers is developed for each user. To access a secure system at a base level of security, a user is asked to answer a group of questions randomly selected from the database and presented to the user for answers. If the questions are correctly answered, the user is permitted access to the secure system. Once access is granted, under certain circumstances, the user can access additional secure systems either as a result of the base level of security previously established, or a higher level of security, which requires the user to correctly answer additional randomly selected questions.

### CROSS-REFERENCES TO RELATED APPLICATIONS

This is a utility patent application, taking priority from provisional patent application Ser. No. 61/126,327, filed May 2, 2008, which is incorporated herein by reference.

### BRIEF DESCRIPTION OF THE INVENTION

A system for collecting personally identifying information from individuals and using that information to verify their identity and permit their access to one or more secure systems via a single login authentication system. Based on a series of questions (opinion-based), a database of answers is developed for each user. To access a secure system at a base level of security, a user is asked to answer a group of questions randomly selected from the database and presented to the user for answers. If the questions are correctly answered, the user is permitted access to the secure system. Once access is granted, under certain circumstances, the user can access additional secure systems either as a result of the base level of security previously established, or a higher level of security, which requires the user to correctly answer additional randomly selected questions.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

Publically accessible communication systems, such as the Internet, have used many different techniques to prevent unauthorized access to secure information. The most common technique used over web-based systems is to have a user pre-register with a secure website by providing a user name (such as “ENTITYTWO” in FIG. 1) and a password. When that user attempts to access the secure website after registration, the user is required to re-enter their user name and password. Many secure systems use blind password entry, where each character entered by the user is replaced with a symbol, such as the “*” shown in FIG. 1, instead of the actual character to prevent passwords from being stolen by someone else watching the user. If the entered password matches the entered user name, then the user is permitted to enter the entire website, or at least that portion of the website that contains secure information for that user.

While this form of security is simple and effective, protecting Roman garrisons 2000 years ago and financial systems today, it also has many flaws. The biggest flaw with such systems is that they are too popular and common. Almost every secure website uses the same form of security, such that users are either required to maintain a common username/password for every website, or adopt different usernames/passwords for many different sites.

The common username/password presents a huge risk for users and website operators because if the common username/password is ever discovered or stolen by a third party, that third party could obtain access to all of the user's secure websites, which are often financial. On the other hand, most users are incapable of keeping track of multiple different usernames and corresponding passwords. As a result, they are compelled to record and hide them somewhere, such as in their computer, wallet, purse or desk drawer. Once again, if this “list” of passwords is discovered or stolen, all of the user's secure information is at risk.

A second flaw relates to the use of blind password entry. Since a user cannot see what they are typing for a password as they type it, typing errors cannot be detected and access can frequently be denied by the secure website. To prevent thieves from guessing passwords for usernames they have discovered or stolen, many websites cut off anyone attempting to enter a secure website incorrectly after three failed attempts. The same security measure applies to legitimate users who have unknowingly mistyped their password three times. To the legitimate user, who may not know why they are suddenly barred from accessing their electronic bank account and must contact their bank to get the problem resolved, this can be a significant problem, especially considering the amount of time the user may be required to spend on the phone attempting to correct the problem. For example, one company requires a user who has forgotten a password to call the company to open a case and mail the company a copy of a utility bill or similar proof of residence, before the company will send the user a new password.

A third flaw with the username/password system relates to the system's vulnerability to phishing attacks. For example, a user may receive an email allegedly from their bank that asks the user to select a hyperlink provided in the email to verify something with their electronic account. In reality, the email is from a criminal that is hoping to trick the user into thinking the email request is actually from their bank. When the user selects the hyperlink (which may be disguised to appear legitimate), the user is taken to a false website that mimics the bank's real website and is asked to enter their username/password. Once they have done so, the criminal captures that information and immediately thereafter accesses the user's bank account and steals the user's money.

Another form of phishing attack involves a criminal mimicking the appearance of a user in a way that convinces a secure website to send the legitimate user's username and/or password to the criminal. For example, many secure websites enable users to be emailed or physically mailed forgotten usernames/passwords. In an attempt to ensure that the person requesting the forgotten username/password is really the user, the requester is asked to answer one or more personal questions (based on information provided during pre-registration), such as their mother's maiden name, their place of birth, etc. If this question is legitimately answered, the username/password is sent to a pre-registered email address or a pre-registered physical address. Since email accessed over unsecured wireless networks can be snooped by criminals and physical mail can likewise be stolen, an enterprising criminal can often get the requested information before the legitimate user can do so.

Many websites make users answer personal questions as an enhanced security measure. As mentioned above, these questions about the users range from their mother's maiden name to the make of their first car. These questions tend to be mostly used for identity verification when a user forgets the username and/or password to the website. Forgetting a username and password by a user is so typical, that almost every website requiring a login to access a website includes a “Forgot Username/Password” link below the login window. If a user forgets their username or password or both, the user is required to answer one or more of the previously answered questions. Another common practice by websites is to keep track of the IP address of the computer which the user is using to access the website. Whenever the IP address changes, such as when the user is accessing the website from work instead of from home, the website notifies the user that a different computer than usual is being used to access the website account, and the user must then go through a verification process, such as answering some of the previously answered security questions or by entering a security code which is sent via e-mail, via a phone voice message, or via a phone text message to the user, who then enters this security code to verify his/her identity. The problem with this approach is that the users have to remember the answers to the questions they previously entered, exactly as they were entered. Many times users are required to answer the questions using a blind entry during registration, where the answer entered is hidden from the user using a “*” as mentioned above. If a user misspells an answer, they can create validation problems when they are required to answer the questions in the future. Further, users must memorize these answers. This means that a user must not only memorize the username and password for the website, they must also remember the exact answers to the security questions, thus increasing the chances of a user making a mistake in future attempts to access a secure website.

One solution to the shortcoming noted above is SITEKEY, a security system used by a variety of websites, including a BANK OF AMERICA website and THE VANGUARD GROUP website. The SITEKEY system user is asked to select a single image from a collection of images. Once the user picks an image, the user assigns the image a label, which can be a word or a phrase. The user then enters a password for the website account. The SITEKEY system is meant to prevent phishing attacks by allowing system users to identify the security image previously selected by the user. A fraudulent website, which does not display the image, or which displays the wrong image, indicates to the user that the website being accessed is not authentic. The problem with the SITEKEY system is that it presents the user with a set of information—the username, the image, the image label, and the password—that must be memorized in order to gain access into a secure website. If a user has accounts on several websites that use the SITEKEY system, the verification information to be remembered by the user grows fourfold.

In a further attempt to improve the username/password system, a number of variant systems have developed, such as the so-called “two factor authentication.” In addition to requiring a username/password, users are also required to enter a special code that has been issued by the website operator to the user and which can only be used once. While effective in theory, the administrative issues associated with such a system are significant and make it unrealistic for widespread usage.

To keep track of account information, such as multiple usernames and passwords, a number of password managers have been developed. For example, KEEPASS PASSWORD SAFE program is a free and open-source password manager available as a desktop application for the WINDOWS operating system. There is also a set of contributed, but unofficial, builds of the KEEPASS PASSWORD SAFE program for desktop and mobile platforms, including APPLE MAC OS X, LINUX, APPLE IPHONE, RIM BLACKBERRY, and PALM PALMOS, among others. The KEEPASS PASSWORD SAFE program allows the user to manage passwords for various sites. The user initially creates a database to store all of the passwords. Access to this database is protected by a single master password or an encryption key file. The advantage of the master password is that the user only has to remember a single password, however, this password must be secure enough; otherwise an intruder could gain access to all of the passwords of the user.

Once the KEEPASS PASSWORD SAFE database has been created, the user enters their current username and password for a website, such as an online bank. The user then visits the website of interest, the online bank, and can (1) either copy the username and password fields to the clipboard, and paste them into the corresponding username and password fields on the website; (2) drag and drop the username and password fields to the corresponding fields on the website; or (3) let the program “auto-type” the information into the website fields to gain access to the secure website. The KEEPASS PASSWORD SAFE program has the advantage of being open-source, meaning that any user can examine the source code to verify the encryption algorithms and that no malicious code has been used, including spyware or adware. Vulnerabilities can also be exposed and brought to the attention of the KEEPASS PASSWORD SAFE developers. Conversely, a user with a malicious intent can examine the source code, find flaws and then exploit those flaws in order to gain access to the passwords of KEEPASS PASSWORD SAFE users. Browser plugins are also provided, which seamlessly allow for usernames and passwords to be entered into various sites, however, these plugins tend to be created by unofficial contributors, and their validity is not ascertained by the KEEPASS PASSWORD SAFE developers, it is up to the user to use them at his/her discretion.

Some other examples of password managers include KEYCHAIN (an APPLE password management system), HANDY PASSWORD (an INTERNET EXPLORER and MOZILLA FIREFOX add-on), KWALLET (a password manager for the KDE desktop environment in LINUX), PASSWORD SAFE (a free and open-source password manager for WINDOWS), and ROBOFORM (a password manager for WINDOWS, mobile phones, and PDAs).

Most web browsers also include a password manager as a default or add-on feature, including INTERNET EXPLORER, MOZILLA FIREFOX, SAFARI, OPERA, and KONQUEROR. These password managers use encryption to store the passwords on a per-site basis, auto-filling in the username and password fields on sites. The user is required to enter the username and password once, and the user is then given the option to save the username and password for future access. Mozilla Firefox further includes a master password feature. When the browser starts, the user is asked to enter the master password once. This is an additional security feature to web browser password managers. If a second user were to get access to the web browser, even if the passwords of the original user were stored by the browser, the second user would need to know the master password to be able to use the stored passwords to access the secure websites.

While password managers are convenient tools for users that lessen the burden of memorizing passwords to different websites requiring a login for access, users still have to go through the trouble of creating a different username and password for each secure access website, many of which demand different syntax criteria for usernames and passwords. A solution to this is the single sign-on method of access control, which enables a user to login once using a username and password to access various websites without having to enter or create a new username and password for each.

For example, the OPENID system is a framework which allows users to create a single identification, username and password, and lets users access various password protected sites by using the OPENID username and password. The OPENID system eliminates the need to create a new username and password for various websites, assuming that these websites being accessed have adopted the OPENID framework. Organizations like AOL, MICROSOFT, SUN, and NOVELL, are examples of large organizations which have adopted OPENID.

Under the OPENID system, a user would typically have to create a new username and password to register for any website, which restricts access to a set of features. The OPENID system allows the user to login and to access the restricted features without having to create a new username and password. While the OPENID system has been adopted by large organizations, as mentioned above, the websites accessed with the OPENID system typically do not demand the higher security levels of many other websites. For example, a blogging website does not require as stringent security as an online bank website. Most online banks and credit card websites have their own username and password management systems for security reasons, in order to prevent users' accounts from being compromised, which can damage a company's reputation tremendously. Thus, while there exist systems such as OPENID that aim to provide ease of use by providing a single username and password to access the resources offered by different websites, the threat of security vulnerabilities explains why more secure websites, such as online banks and credit card companies, have not adopted the OPENID system. Finally, an unsuspecting user making use of the OPENID system can also be subject to phishing attacks, thus allowing the malicious user to gain access to sites that support OPENID.

Other frameworks similar to the OPENID system have been built by GOOGLE and MICROSOFT. The username and password selected by a user creating a GOOGLE account allows that user to access the various services provided by GOOGLE, such as e-mail, calendar, photos, documents, among others. Similarly, MICROSOFT's WINDOWS LIVE ID system is a single sign-on service for many of MICROSOFT's websites, most notable HOTMAIL, MSN, XBOX 360's XBOX LIVE, and MESSENGER.

MICROSOFT's CARDSPACE is WINDOWS software for managing multiple online identities where the online verification process is compared conceptually to presenting a physical identification card such as a driver's license, a passport, or a credit card for verification of one's identity. A user creates a set of identification cards, each one potentially carrying different types of information, depending on the identification requirements set by secure access websites. The identification card can be used for multiple websites, so a card does not have to be created for every single website. The identification cards are then signed using encryption before they are sent to websites for verification and authentication. The use of encrypted digital signatures prevents imposters and thwarts malicious users attempting to forge the digital signature.

The information card is signed using the user's private key. The information card is then sent along with the user's public key. This process allows the secure access website to verify the integrity of the information sent by the user, since only the private key can be used to change the digital signature, and malicious tampering can be detected. Despite all of its security features, the CARDSPACE system still has security flaws. Users are still subject to phishing attacks and the security certificate of a website can be tampered with, making the user believe that the website being accessed is legitimate, thus allowing a malicious user to steal verification and authentication information from the user. Although the CARDSPACE system can be further protected through use of a master password, if the user does not set a master password, or if the password is stolen, an intruder can readily gain access to the user's secure websites by using the identification cards.

Many other secure systems have similar security flaws associated with their access control systems that are being circumvented by criminals. For example, automated teller machines (ATMs) traditionally require a user to input their bank card or credit card and enter a personal identification number (PIN). Using various means, criminals are forcing victims to provide their PIN, whereupon the criminals visit a variety of ATMs and steal as much of the victim's money as they can over a course of hours or days. Other secure systems, such as automotive ignition systems, home security systems, restricted access systems, parental control systems, and a variety of other applications that require some level of security before permitting something to happen, utilize security technologies that can be easily circumvented. For example, fingerprint systems can be circumvented by lifting a legitimate user's print and recreating their fingerprint on an artificial finger; retinal scans can be circumvented by artificial eyeballs that simulate an eye and blinking eye lids; voice detection systems can be circumvented by voice impersonation and recordings; and even 256 to 512 bit encryption-based systems can be cracked by a cluster of personal computers.

A different type of authentication system is described in U.S. Patent Application Publication Number 2005/0039057 (“Bagga et al.”). Bagga et al. describes the use of multiple choice questions as part of an authentication process. Users are asked opinion questions or similar types of questions, but given a limited set of choices for answers. For example, the question of “Favorite Marine Animal” can only be answered as “whale,” “shark”, “dolphin” or “seal.” When the user seeks to be authenticated, the user must remember the answer chosen among the four answers provided. Likewise, users can create answers to questions, like a personal identification number (PIN), but the user must remember those answers exactly as well. Hence, while Bagga et al. sought to improve the authentication technique by changing the nature of some of the questions, the same issues that exist with other systems, such as remembering an answer previously chosen among other equally plausible answers or remembering answers like PIN numbers.

Accordingly, better access control systems are needed that do not suffer from the shortcomings of the prior art and which can be used to provide users and secure systems with a better form of security.

### BRIEF DESCRIPTION OF THE SEVERAL VIEWS OF THE DRAWING

FIG. 1 illustrates a prior art user interface dialog box for entering a standard username and password form;

FIG. 2 illustrates a registration screen in accordance with an embodiment of the present invention;

FIG. 3 illustrates a question screen in accordance with an embodiment of the present invention;

FIG. 4 illustrates how a unique user handle can be constructed from personal user information in accordance with an embodiment of the present invention;

FIG. 5 is a flow chart illustrating the initial synchronization between the present invention and a password protected website in accordance with an embodiment of the present invention;

FIG. 6 is a flow chart illustrating the user verification process in accordance with an embodiment of the present invention;

FIG. 7 is a flow chart illustrating how the security level for a website is determined in accordance with an embodiment of the present invention;

FIG. 8 is a flow chart illustrating how the PIN number, which represents the position of the correct answers to the questions asked during the verification process, is determined in accordance with an embodiment of the present invention;

FIG. 9 is a flow chart illustrating how the question screens are presented to the user in accordance with an embodiment of the present invention; and

FIG. 10 is a flow chart illustrating the verification of the identity of a user accessing a banking website in accordance with an embodiment of the present invention.

### DETAILED DESCRIPTION OF THE INVENTION

In accordance with the preferred embodiment of the invention, when a user seeks to initiate a session on the Internet, on their computer, or gain access to any other secure system, they are randomly presented with a number of questions about themselves from a database established by the user during a prior enrollment session. The questions presented to the user are never factual in nature, such as “What is your mother's maiden name?” The answers to factual questions such as this are easily retrievable from public databases and are usually widely known to a reasonably large group of people besides the user. On the other hand, questions based on opinions cannot be easily discovered by someone wishing to circumvent the security system. Accordingly, the questions must have a semantic quality that leads them to be opinion-based rather than fact-based.

The invention consists of a single login authentication system, which enables a user to access one or more secure systems. In the preferred embodiment of the present invention, the single login authentication system is used to access password protected websites, but it can be extended to access protected systems, such as authorization of a driver before a car is started, or for identity verification when using an ATM machine, or for access to purchased media such as software or music.

During a registration session the user is presented with a large number of registration questions. The user decides which of these registration questions to answer, by entering a textual response to the registration questions the user wishes to answer. These registration answers are stored in a database and are used to build an identity profile for the user. However, the user can initiate subsequent registration sessions, where the user can answer additional registration questions in order to increase the pool size of the answered registration questions.

When the user wants to access one or more secure resources, the user goes through a verification session in order to validate the identity of the user with the single login authentication system. During the verification session, the user is asked a set of verification questions. These verification questions are taken from the set of registration questions answered by the user during one or more registration sessions. Each question is presented along with a set of verification answers. The correct verification answer is the registration answer provided by the user to the same question during one or more registration sessions, while the rest of the verification answers presented are incorrect verification answers, which may be generated in a variety of ways as further discussed below. If the user selects the correct verification answer, then this counts as a positive match. The user's identity is verified once the number of positive matches reaches a threshold level. This threshold level will typically be a security level which is specified either by the user or which can be specified by the secure systems.

To simplify matters from hereon, the security questions asked to the user for security verification and authentication during registration and verification sessions to access a secure system or resource, such as a website or copyrighted material purchased by the user, will be referred to as questions or “Cyber questions.” Furthermore, the present invention will be referred to as CyberKeyP™.

A list of possible Cyber questions includes:

What actor can play any part?

What actor would you stop from making movies?

What actress deserves to win an academy award?

What actress makes you yell ‘Cut’?

What male songwriter would sing the soundtrack to your life?

What male singer makes you hit the mute button?

Which female songwriter would sing you happy birthday?

Which female singer's voice hurts your ears?

What male athlete should be on a cereal box?

Who is the male athlete you would most like to see on the bench?

Who is the female athlete with the most impressive physique?

Who is the female athlete you would like to see pull a muscle?

Which man has had the greatest impact on the world to date?

Who is the most despicable man in history?

Which woman's ideas and actions have changed the world?

What woman in history gives you both the ‘heebies’ and the ‘jeebies’?

What male scientist deserves a gold-plated beaker?

What male scientist's work has been detrimental to humanity?

While there could be any number of Cyber questions developed, the preferred embodiment of the present invention utilizes a total of 200 such questions. The exact nature of each question is not as important as the fact that they are opinion, versus fact based, such that research about the user cannot be used to easily circumvent the security of the system. What makes the present invention secure is the ratio between answered and unanswered questions. Thus users are not expected to answer all 200 questions. In the preferred embodiment of the present invention, each user will be required to compile a database of at least 35 questions/answers, but in order to prevent a user from refusing to finish the enrollment session, users are only expected to answer 10 initial questions, with additional questions/answers being added later.

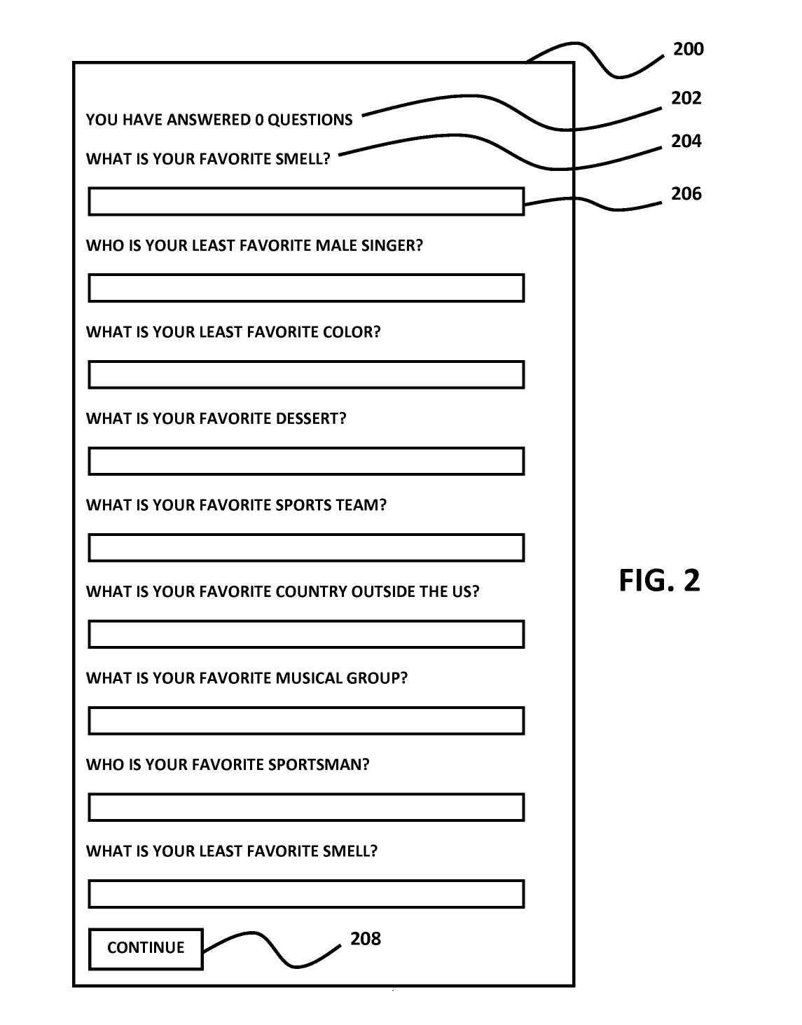

During the registration or enrollment session, each user will be presented with a series of screens including 10 randomly selected questions. An example question screen 200 is illustrated in FIG. 2. At the top of the question screen 200, a counter 202 informs the user the number of questions which have been answered up to that point during enrollment. As the user answers questions, this number will increase to reflect the number of questions answered by the user. The question screen 200 includes ten randomly selected questions 204. The user can enter answers to the questions on the text entry 206. The user can answer any number of these questions, but must answer at least one before being presented with the next screen of questions. The user must press button 208 to continue to the next question screen. Pressing the button 208 allows for the user's answers to be saved and to update counter 202. This process continues until a total of 10 questions have been answered. Each time the user initiates a secure session after enrollment, the user will be presented with another screen of ten questions until a total of 35 questions/answers have been compiled, although larger and smaller numbers of questions could be asked from a larger or smaller total. To prevent automated screen readers (also known as “screenbots”) or other forms of spying software from being able to scan question or answer screens, visual distortion technology will be utilized to display answers (at least, and possibly also questions) in a form that humans can read and machines cannot. The questions will also be grammatically structured to prevent these programs from determining the actual semantic of the questions.

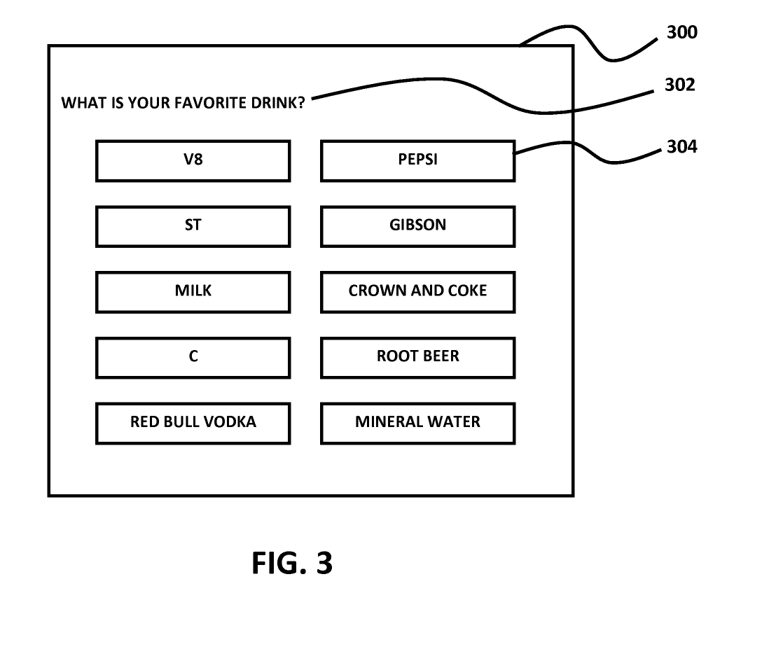

As illustrated in FIG. 3, when a question screen 300 is subsequently presented to a user during a secure session, the question 302 will be accompanied by a number of possible answers 304, a set, one of which was previously provided by the user, and the remainder of which are false. When the answer is selected, the user is presented with another question and set of answers, regardless of whether the prior question was correctly answered. In this manner, the user may be presented with two or more questions without knowing whether any prior answer was correct. Depending on the number of correctly answered questions, the user may be granted access or required to answer more questions correctly.

Once the user has answered all of the questions presented, the user's answers are compared against a unique, temporary identifier (PIN, as further explained below) that was created based on where to position the correct answers (among all of the incorrect answers) to the questions presented to the user. Once the user's identity is verified by the system, the user's identity can be verified to any other secure systems, such as other websites, (utilizing the system of the present invention) that the user may wish to visit during a secure session. Some of these websites may be satisfied with the level of security established by the session initiation process, while other secure websites may require a greater level of security, which can be obtained by having the user correctly answer additional questions.

No secure access session initiated by the system will ever be the same. Each user database contains a sufficiently large number of questions and answers to enable the user to be presented with a different set of questions most of the time. The system also keeps track of what questions have recently been asked and answered (correctly or not), and blocks those questions from being re-asked until all of the other questions have been used. Furthermore, the organization of the questions and the order in which questions are presented is random, so the system cannot be easily circumvented.

To further protect the system from being circumvented, all questions will be issued a weighing factor based on the probability that an answer to a question might be guessable by someone other than the user. The weighing factor will be used to deemphasize certain questions that could be guessed and will either prevent them from being used at all or used very frequently. For example, if one of the questions was “Who is the man in history you hate the most?” and a large portion of the user base answered that question the same way, i.e., “Adolf Hitler,” then someone wishing to circumvent the system, upon seeing “Adolf Hitler” as one of the possible answers, might be able to guess and pick the right answer. Accordingly, if a statistical analysis of answer frequencies reveals any question/answer combination to share a common answer among users, then that question/answer combination, for those users, will be weighed less important and deemphasized as noted. There are many similar statistical analysis methods which can be used to determine the weighting factor or factors. It is not possible, realistic or necessary to attempt to explain all of those methods in this description. Moreover, it is not necessary to describe such methods herein because anyone of skill in the art of the present invention will be able to implement such functionality.

The assignment of a weighing factor for every question/answer combination for every user ensures that the database of questions/answers will be unique for every user. The user database of questions and answers will also be tailored for each user in a number of other ways. First, the user is allowed to pick and choose from a large number of different questions for which to provide answers. Accordingly, some users may choose to answer all of the questions, while other users may chose to not answer one or more of the questions. Second, all of the questions require a unique answer from the user, versus selection of a pre-established answer from a list of pre-established answers.

Third, since it may be difficult for users to remember each of the answers they provided, users are not expected to remember the exact answers they provided to each question, they are only expected to recognize those answers when they see them in the future. For example, as illustrated in FIG. 3, in accordance with the present invention, when a question is presented to a user it is presented along with a number of possible answers, one of which will be correct and the others incorrect. Hence, the user need only recognize the correct answer from among the incorrect answers.

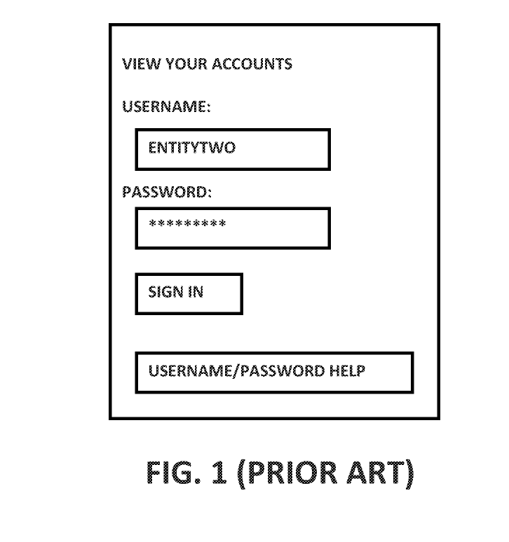

In prior art security systems, the user is expected to remember both a user name and a password, exactly as they were entered. FIG. 1 illustrates a prior art user interface dialog box 100 for entering a standard username, such as ENTITYTWO, and password, which is hidden and indicated by a series of dots. If the user cannot enter the username and password correctly, the user is barred access to the security system. Even though a user may try to use a common password for all of their secure access systems, they may not be able to do so because many prior art systems require passwords to meet different minimum security standards. One system may require passwords to be only four characters long (while being case sensitive), while another system may require a password to have at least eight characters and include letters, numbers and at least one or more special characters, such as _, @, %, etc.

In further contrast to the prior art, the present invention can be structured to allow a user to answer any question in any manner they desire, using any number of letters, numbers, special characters, upper/lower case letters, etc. Rather than attempt to conform the user's answer to a set form, the false answers that are presented to the user with the correct answer are based on the manner in which the user wrote their correct answer in the first place. For example, if in response to the question “What is your favorite city?” the user responded with the following gibberish answer “XYZ 7%Q9,” this “correct” answer would still be presented to the user in the future with the question, along with a number of other similar “gibberish,” but false answers, such as “Poly56*,” and “4#t)̂ LP,” among other false answers. Alternatively, the system could also establish some base level requirements for acceptable answers to each question. If a user's correct answer at registration did not meet this base level, they would be required to create a new answer that was more acceptable. Users may also be given some helpful instructions and/or guidelines at this stage as well.

There are several ways to generate false answers presented to the user. In one embodiment of the present invention, the answer provided by the user to a question can be analyzed first by doing a simple check against a dictionary. If the answer provided by the user is a single dictionary entry, then false answers can be generated by finding synonyms and antonyms to the single dictionary entry. If the answer provided by the user consists of several words, but which do not constitute a sentence, then synonyms and antonyms for each respective word can be searched to generate a set of false answers. In another embodiment of the present invention, if the user entered a random sequence of characters by typing on the keyboard, then a set of false answers can be generated by applying modifications to the sequence of characters. For example, if a user typed in “;amfqo” as an answer, then every other character could be changed to a randomly picked character, resulting in a false answer such as “;bmoga”. Of course, making a false answer too close to a made up correct answer may result in making it too hard for the authorized user to recognize his/her correct answer. Alternatively, the provided answer can be split into several segments, and entire segments could be replaced with a set of new characters. As noted, while identifying the correct answer when gibberish is entered by the user will make it difficult for the user to recognize their previously entered answer, it also deters intruders from being able to guess the right answer when an answer containing only gibberish stands out as the right answer among a set of answers containing normal words.

In yet another embodiment of the present invention, a grammar could be induced or trained in order to parse free text. This particular embodiment can enable the parsing of sentences entered by users of the system, so that a user is allowed to answer a question by entering a word, or a complete sentence. The text parser could be based on a context-free grammar, either created from scratch or a grammar whose rules are learned through training by observing example sentences.

In the preferred embodiment of the present invention, the answers entered by other users for the same question are used as incorrect answers on each question screen during verification. The answers provided by users to questions can be grouped together based on a variety of demographic information, such as age, country, cultural influences, and other attributes collected by the system during the initial registration process. For example, the false answers for a middle-aged user from France with Armenian ancestors may consist of answers provided by other users with similar demographic backgrounds.

In order to further enhance the security of the verification session, a “None of the Above” option can be included as one of the answer options for each question during verification. If none of the answers presented to a user on a question verification screen appear to be correct, then the user can select the “None of the Above” option. This option may be provided numerous times or just once per verification session. For example, when a user is asked to answer four questions in order to verify the user's identity, on the second question screen, all of the answers provided are false. In this case the user would select the “None of the Above” option for the second question. If the user were to select the “None of the Above” option for a question where the right answer was present, then the response would be marked as incorrect.

The list of possible questions is endless. Factual questions, such as “What is your mother's maiden name?” are to be avoided because the correct answer can often be found through other sources, i.e., other than through the mind of the user. Whereas, opinion questions, such as “Your favorite sports team,” are much harder to find out through other means. Even if the user has painted the outside of their house in the team colors of a sports team and only wears that team's jersey for a shirt every day, they may still have answered a different team name during registration, and only that user would know.

The number of questions a user is asked depends on the security level established for that user and what the user wants to do. If the system is being used for Internet access security, the user might be required to pass security level 2 before being provided basic access, meaning that the user has to answer two questions correctly (out of two questions) to be allowed basic access. Each website that the user might want to visit has the option of accepting the user, based on the user's basic access authorization, or can establish a higher security level. If a website established a security level 4, then the user would be asked two additional questions. If a website does not establish a security level, one will be set by default, such as the preferred security level 4. The system also tracks the activity of the user to make sure the user has not left their computer unattended and therefore open for use by someone else. Accordingly, after a period of inactivity, a user might be required to answer additional questions correctly to be permitted access again. The additional questions asked following a period of inactivity is also referred to herein as an inactivity verification session.

The number of answers presented to a user with each question can depend on the screen size of the security system the user is utilizing. For example, if the user was using a computer with a normal sized monitor, then the user might be presented with six answers from which to choose, but if the user was using an access device with a small screen, such as a mobile phone, then the user might only be presented with three answers. Presenting a user with anything less than three answers is not preferred because it increases the likelihood that an unauthorized user could simply guess at the answers and by sheer luck, answer correctly. The more answers presented, the harder it becomes for an unauthorized user to guess correctly on all of the questions.

In order to track each user and their security level, once access has been granted to a user, each user is generated a new unique PIN number before each new security level session, based on the present security level, screen size, and a randomness generator. For example, if a user was at security level 4 and had a screen size that permitted the listing of 10 answers, then the correct answer would be randomly placed among the ten answers for four questions. If the correct answer to question 1 was at position 3, the security level session would be assigned the number 3 for the first digit of a four-digit PIN. If the correct answer to question 2 was at position 7, the security level session would be assigned the number 7 for the second digit of the four-digit PIN. If the correct answer to question 3 was at position 4, the security level session would be assigned the number 4 for the third digit of the four-digit PIN. If the correct answer to question 4 was at position 3, the security level session would be assigned the number 3 for the fourth digit of the four-digit PIN. Hence, the PIN would be 3743 for that security session. When the user has answered all of the questions, the system would check to see if the answers selected by the user matched the PIN, and if they did, the user would be accepted, and if they did not the user would be rejected.

If the user was accepted and was thereafter inactive for a period of time, additional questions would be asked and the PIN would change. If the user visited a website with a higher security level and more questions needed to be asked, the PIN would change. The next time the user started a security session, even with the same security level and the same screen size, the PIN would change because the position of the correct answer among the list of answers is always being randomly changed.

In the event a user gets an answer wrong while going through any secure access session, the user might have the opportunity to avoid going through the entire process again by being asked one or more additional questions and providing correct answers to those questions. For example, if the user gets more than 50% of the answers correct, but not all, then the user might be asked to answer the same number of questions incorrectly answered to see if those additional questions can be answered 100% correctly. If the user succeeds, access would be granted. If not, the user would be required to start all over.

Once access has been granted through use of the present invention, existing authentication technologies, such as the KERBEROS protocol suite developed by the MIT Kerberos Consortium or SHIBBOLETH, an open-standard authentication system developed by Ohio State University, could be utilized to distribute authentication and authorization within and between federated enterprise, peer-to-peer communities and other computer networks. Alternatively, public-key authentication could be used, with CyberKeyP creating a public/private key pair for a user. The information can then be encrypted and signed with the private key, allowing any of the websites with the corresponding public key to verify the integrity of the message received. A website can also use this same public key, distributed by the user, to encrypt information, which can then only be decrypted with the user's private key, protecting the data from eavesdroppers, who would not be able to decrypt the intercepted information without the private key.

The present invention can also be used for management of copyrighted material, including but not limited to pictures, music, videos, movies, and software. From here the term “media” will be used to define one or more of the following: pictures, music, videos, movies, and software. CyberKeyP can be used to allow a user to access a purchased media product. For example, if a user purchases a license for a software program A and installs it on a laptop computer, a CyberKeyP registration process could be utilized when the user sought to register the software. However, if the user sought to use this same software on a desktop computer, the user would have to successfully authenticate their identity with CyberKeyP on the desktop computer, which would then permit the user to download the software program A onto the desktop computer (such as from online).

Alternatively, a user might be required to use a CyberKeyP authentication session each time the user sought to use a registered software product. To prevent users from transferring copies of the media to multiple computers thereafter, some of which might not be the user's primary computer, once the CyberKeyP session ends, all or some portion of the media could be converted to inaccessible data. This can be done by encrypting the media once the CyberKeyP session ends, by either using a proprietary algorithm, private key algorithms (DES, AES), or public key algorithms (RSA, PGP). Since the particular encryption algorithm used for different types of media could vary significantly, it is not possible, realistic or necessary to attempt to explain all of those methods and attributes in this description. Moreover, it is not necessary to describe such methods or attributes herein because anyone of skill in the art of the present invention will be able to implement such functionality.

In the preferred embodiment of the present invention, the CyberKeyP system would be accessible via a website. Certain features, such as the list of websites that have been approved for password-free access can be part of a browser add-on. In yet another embodiment of the present invention, the CyberKeyP system would be accessible via a desktop application. A user could download the CyberKeyP system software, install it on their computer, and access it similar to any other program installed on the user's computer. The database containing the pool of questions answered by the user and the answers provided by the user can be stored either on the user's computer or it can be stored online.

In the desktop embodiment of the present invention, when the CyberKeyP system program is started, the system could communicate with the database, depending on whether it is stored on local storage or remote storage. The user would then proceed through the standard authentication. Ideally, after verification, a public-private pair key would be generated to enable communication between the secure access websites and the CyberKeyP desktop application. In yet another embodiment of the present invention, the database containing the user's pool of questions and corresponding answers would be stored on a removable storage device, such as a USB flash drive. The user could then carry this removable storage device and use it for authentication and verification of their identity, without having their database stored in their computer's local memory, or on an online server.

Although the CyberKeyP security system seems rather simple, it provides a serious level of security in comparison to existing password-based security systems. The strength of a typical password is mathematically defined according to the following formula,

$$H = x \cdot \frac{log ( L )}{log ( 2 )}$$

where x represents the length of the password and L represents the number of possible characters that comprise a given type of password. For example, a four-digit ATM PIN-code includes only the numbers 0 through 9 for a total of 10 possible valid characters. The bit entropy of a four-digit ATM code, by plugging in four and 10 in place of x and L in the formula above is:

$$4 ⋆ \frac{log ( 10 )}{log ( 2 )} = 13.28$$

If we apply this same formula to the CyberKeyP algorithm, in the case where a user is asked four questions, and the user must identify the correct answer out of 16 possible answers, the bit entropy would be:

$$4 ⋆ \frac{log ( 16 )}{log ( 2 )} = 16$$

Bit entropy of a password is a measure of randomness. Hence it can serve as a measure of the strength of a password against a brute-force attack. However, the true strength of CyberKeyP is that the login credentials (the PIN code) changes for each new secure session. As such, every verification requires a completely unique “PIN code.” This would be equivalent to a user creating a new PIN code or password every time they desired to gain access to a secure website. If this fundamental component is incorporated into the equation, the full strength of the CyberKeyP system is demonstrated. The CyberKeyP bit entropy equation, which incorporates the multiple login component, is defined as follows,

$$H = \frac{log ( \frac{1}{{( \frac{1}{{A}^{q}} )}^{n}} )}{log ( 2 )}$$

where A represents the number of answers displayed on screen, q is the number of questions presented during verification, and n is the number of verifications. In comparison to the standard bit entropy demonstrated above, if only one variable is changed, for example the number of verifications (also known as “logins” with a standard password) is changed to two, the resulting bit strength computes to 32. An ATM PIN-code would have to be 10 digits long to exceed this level of security by CyberKeyP (10*log(10)/log(2)=33.2). As we further increase the number of verifications in the CyberKeyP bit entropy equation to five, we find that an ATM PIN-code would have to be 24 digits long to match the CyberKeyP level of security against a brute force attack. A possible 24 digit PIN-code might look like the following “564389753237453223326787”.

The security of CyberKeyP comes from the verification process which occurs during an Internet session and is different for every subsequent Internet session, allowing the user to pick the correct answers from a set of answers to a question, and repeating this for several questions based on the security level needed. The advantage of the CyberKeyP system was demonstrated above over a digit based PIN-code, such as those used for an ATM. Most websites require more stringent requirements for passwords. The typical set for a password consists of the 26 letters of the alphabet, the numbers 0 through 9, and a set of special characters, typically 10 (such as “%”, “$”, “*”). Assuming a case-sensitive password (where there is a difference between lowercase and uppercase letters—“hello” is different than “HELLO” and different than “HeLIO”) with numbers and special characters, for a total of 72 possible characters (26 lowercase alphabet, 26 uppercase alphabet, 10 numbers, and 10 special characters). Given that the average American Internet user logs on to password protected websites approximately 25 times per month, if we enter this value into the CyberKeyP bit entropy equation (by changing the value of n to 25), the entropy value becomes 400. To generate a similar level of protection, even using the 72 possible characters of a standard password, the password would have to be 65 characters long. For example, “e3hde67hgf378kjgf456mnbfrt34g3457ko9786AS*%53km n69765nhgf29830kab” is a 65 character password.

The security of the CyberKeyP system lies in its uniquely and randomly created PIN-code per Internet session. If the user visits a website that requires a higher level of security or if a user has been inactive for a certain period of time, just a few more questions are asked. This is a simple process that greatly increases security. At the same time, at no point is the user required to memorize cryptic passwords or to maintain an association between different usernames, passwords and websites, which can lead to confusion and the entry of the wrong password at the wrong website.

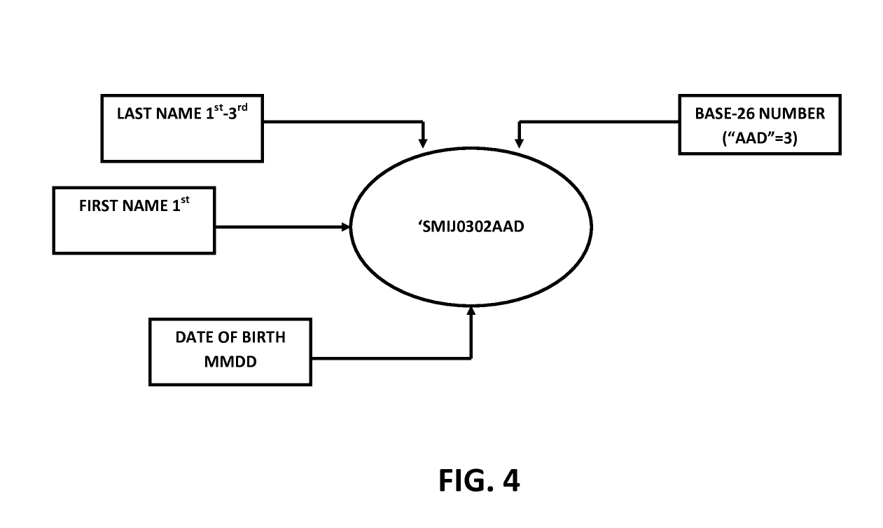

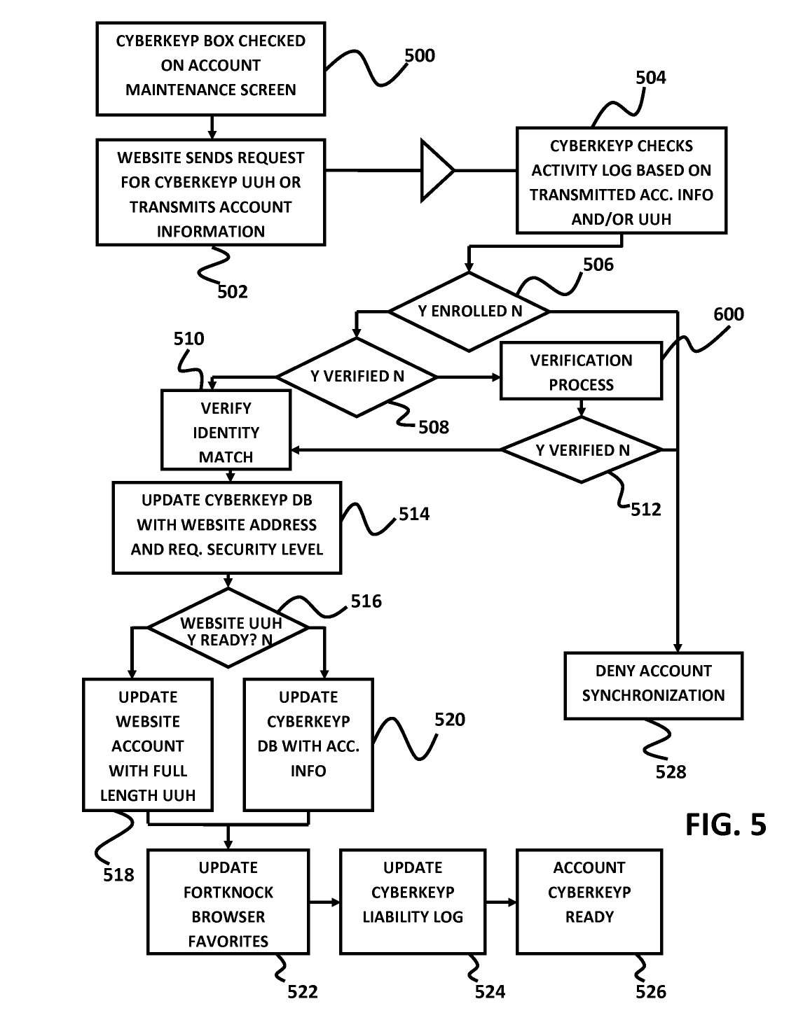

To add a further level of protection when the CyberKeyP system is used in association with websites, a user can be issued a unique user handle (UUH) at the time they are registered, which can then be used at a subsequent point in time to further identify the user, as will be further described below. The construction of the UUH is demonstrated with reference to FIG. 4, and its utilization with reference to FIG. 5. As set forth in FIG. 4, for a user named John Smith, born on March 2, the UUH would be SMIJ0302AAD, where “SMI” are the first three letters of the last name, “J” is the first letter of the first name, “0302” is the birth month and date, and where “AAD” is a base-26 number equal to 3. The base-26 number system uses the letters of the alphabet A to Z to represent the numbers 0 to 25. Methods for converting from the base-26 number system to decimal numbers are known in the art, similar to how the binary and hexadecimal number systems can be converted to decimal.

Before further describing the UUH, however, it is necessary to provide further details regarding the overall usage of the CyberKeyP system. Accordingly, FIG. 5 provides a flow chart illustrating the initial synchronization between the present invention and a password protected website in accordance with an embodiment of the present invention. In step 500 the user accessing an existing account on a password protected website is given the option of marking a checkbox that will enable CyberKeyP verification with the website. The checkbox could read “Enable CyberKeyP Verification,” or something similar, thus allowing for the website and CyberKeyP to synchronize and to enable the user, on future access, to gain entry to the password protected content through CyberKeyP authentication. Instead of a checkbox, many other types of user interface representations can be used to present this option to the user, such as a push button, a menu item, an entry from a pull-down menu, a pop-up dialog, etc. To simplify matters from hereon, the enablement of the CyberKeyP verification process will be illustrated with a checkbox.

In an embodiment of the present invention, once a secure session has been initiated, after the user completes the verification process, the CyberKeyP system will alert websites that have been previously enabled to use the CyberKeyP passwordless authentication, or single login authentication system, that the user has initiated a secure Internet session. This will allow for a preliminary exchange of authentication information for the user, consequently speeding up the actual authentication once the user visits a CyberKeyP enabled website.

In step 502 the website sends a request for the UUH to CyberKeyP or automatically transmits the current website account information to CyberKeyP. The synchronization process is then started by the website. For example, if the user wants to use the CyberKeyP system to access an online banking account, the user will access the banking account website and mark the option enabling CyberKeyP system authentication through the account preferences screen or dialog. Once this has been activated, the online bank account will then initiate the synchronization process with CyberKeyP. Once synchronization has been completed, the simplified CyberKeyP process can be used for future logins.

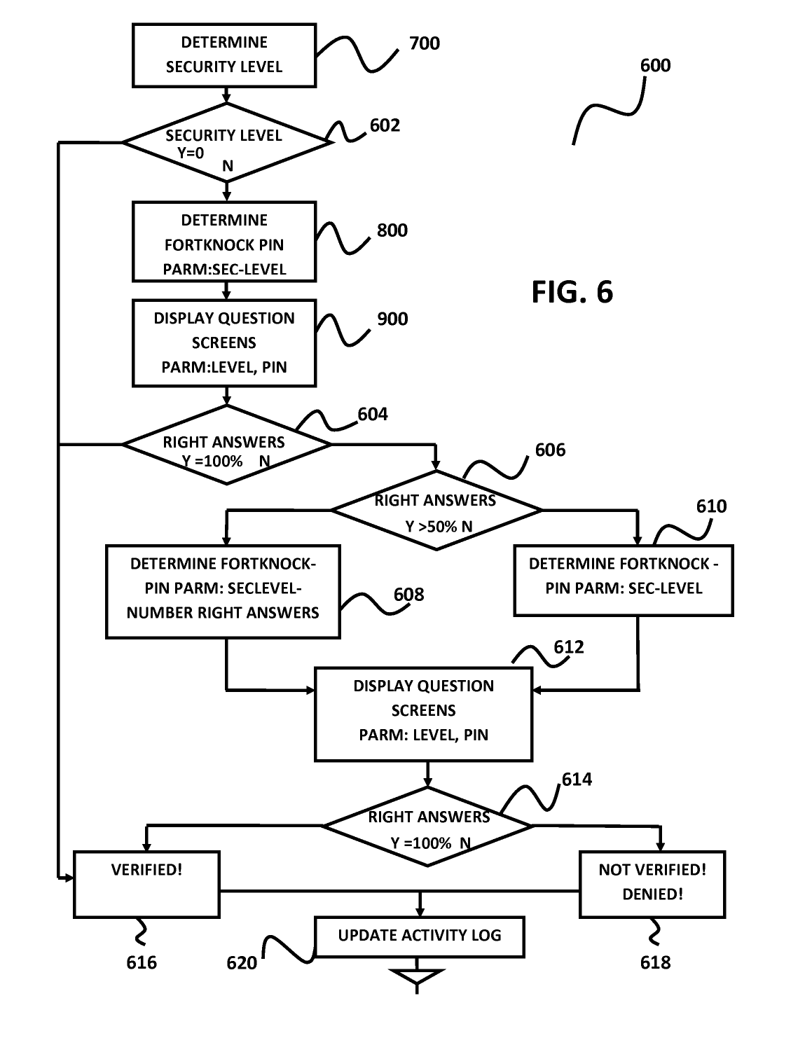

In step 504, the CyberKeyP system checks the activity log based on the transmitted account information or based on the UUH. The activity log contains all information about the currently verified user and the user's current security level. Step 506 checks to see if the user is enrolled with the CyberKeyP system, since a user without a CyberKeyP system account can potentially check the CyberKeyP authentication checkbox. If the user is not enrolled with the CyberKeyP system, then the account synchronization is denied and the user is informed, step 528. On the other hand, if the user is enrolled, then step 508 checks if the user has been verified based on the user's current security level and the website's required security level. A user which has not been verified must go through the verification process, step 600, which is illustrated in further detail in FIG. 6. In step 600, the user goes through the process of answering questions to meet the required security level. Once the verification process has been completed, step 512 checks to see if the user was successfully verified, denying account synchronization in step 528 if verification failed, or allowing for verification of the identity match in step 510 if verification was successful. After the CyberKeyP system has confirmed that the current user is enrolled and verified, the current website (along with its required security level) is added to the database for future CyberKeyP access in step 514.

Websites which interface with the CyberKeyP system may choose to use the UUH for seamless communication. However, even if a website chooses not to use the UUH, the CyberKeyP system can still communicate with the website. Step 516 checks whether the website will use UUH for communication with the CyberKeyP system for authentication. If the website is UUH ready, then the user account on the secure website is updated with the full length UUH, step 518. In the case where the website is not UUH compliant, the CyberKeyP database is updated with detailed account information about the current user and the website, step 520. As a usability feature, the CyberKeyP system will provide a list of websites that have been approved for password-free access for the user and offer that list as a browser add-on. This list of websites is updated in step 522 to include the new secure website. Detailed logs are kept by the CyberKeyP system during verification and synchronization for liability purposes, step 524. Step 526 completes the synchronization process.

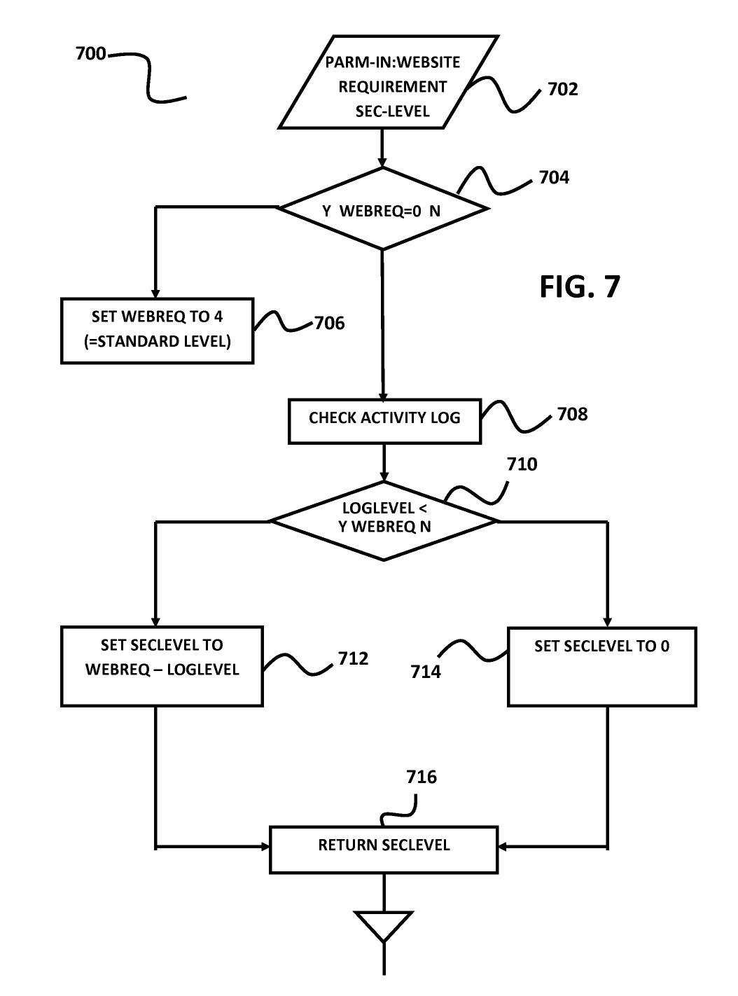

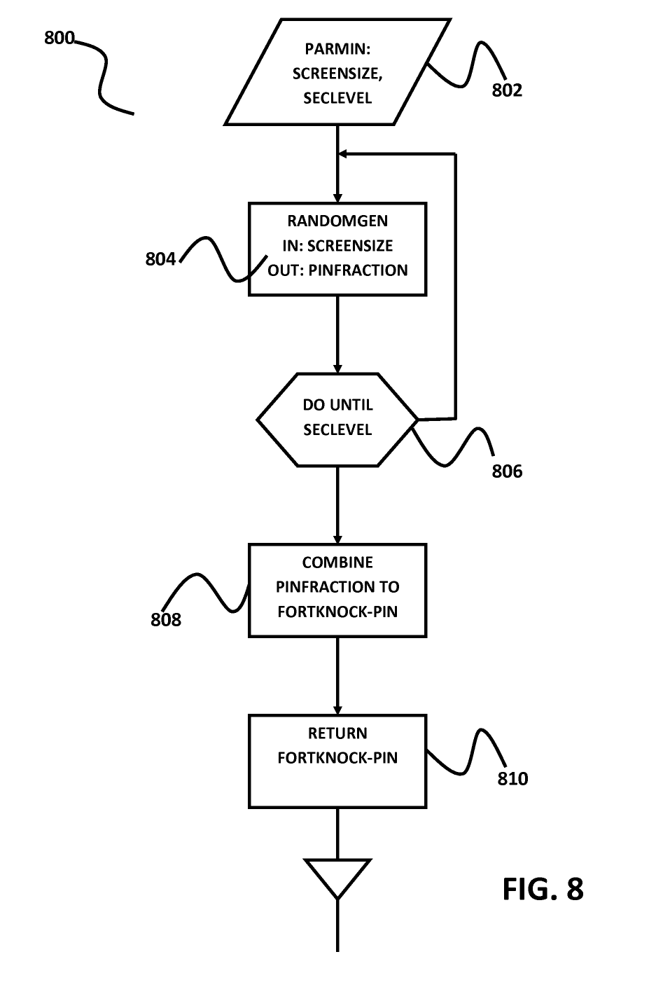

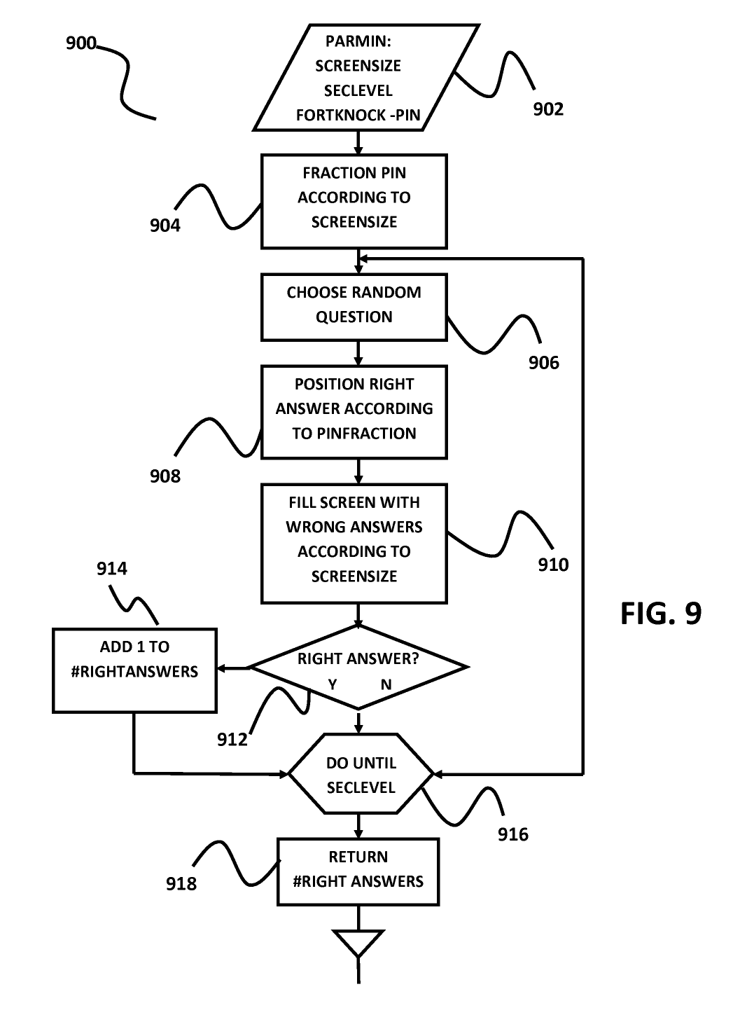

The security level desired by the user or required by a secure access website determines the number of questions the user has to answer in order to be verified. FIG. 6 shows in detail the verification process. Step 700 determines the security level, as is further illustrated in FIG. 7. Step 602 checks if the security level is zero. A security level equal to 0 indicates that the user is verified to access the website. This is a result of three events: (1) the user has been verified before, (2) the website the user is trying to access does not require a higher level of security, and (3) the user has not been inactive for a prolonged period of time. Step 800 determines the PIN that is used for the authentication with secure sites, as is further illustrated in FIG. 8. The PIN number represents the position of each correct answer on the screens of the Cyber questions. Further details are presented below. Step 900 displays the question screens to the user and accepts the user's answers, as is further illustrated in FIG. 9. Step 604 checks whether the user answered all questions correctly. If all of the answers are answered correctly, then the user is verified, step 616.

Step 606 checks to see if the user answered at least half of the questions correctly. If the user got more than 50% of the answers right, the user gets a second chance with just the amount of questions the user missed. For example, the user is presented with four questions, and the user answers three of them correctly. As a result the user is required to answer one more question correctly in order to get verified. Step 608 computes the number of additional questions to be asked of the user if the user answered over half of the questions correctly. In the case where the user answers less than 50% of the questions correctly, then the user has to answer all questions correctly again. Step 610 sets the security level to the full amount of questions again. For example, if the user is presented with four questions and only answers one out of the four questions correctly, the user will then be asked four more questions in order to be verified. Step 612 displays the additional questions based on the updated security level set in either step 608 or 610.

Once additional questions, or a whole new set of questions, have been asked and answered by the user, step 614 checks to see if the user answered all questions correctly. Answering all questions correctly leads to a verified status in step 616, otherwise the user is not verified and access is denied in step 618. Finally, step 620 updates the activity log. The activity log keeps track of the time of inactivity to make sure the user did not leave the screen open, thereby giving somebody else the opportunity to access the website without the user's approval or awareness.

Each individual website can submit a security level requirement to the CyberKeyP system. A banking website requirement will tend to be higher than the requirement for a social networking website, but websites have the freedom to establish any security level they desire. FIG. 7 shows steps 700 involved in determining the security level needed to meet the website's security requirements. Step 702 shows the website security level requirement as a data parameter to this process. Step 704 checks to see if the website submitted a security level requirement, with a security level requirement of zero meaning that no security level was submitted by the website. A standard security level requirement of four is used as the default for websites which do not provide a security level, step 706.

The activity log determines how long the user has been inactive during the current Internet session. The activity level, labeled “loglevel” 710 in FIG. 7, is reduced after periods of inactivity as an additional security measure. A reduced activity level, in turn, results in an increased security level. This is to protect the user from unauthorized access after the user has stopped using the Internet session, but did not close the Internet browser properly. Step 708 checks the activity log, with step 710 determining whether the activity level, is less than the website security level requirement. A high activity level represents activity by the user, while a low activity level represents inactivity by the user and a potential security threat. When the activity level is greater than or equal to the website security level requirement, the security level is set to 0 in step 714 and returned in step 716, representing that the user was successfully verified to access the website. If there have been periods of inactivity by the user, one reason being that the user's computer has been left unattended for some period of time, the activity level will be less than the security level, triggering additional questions to be asked. In step 712, the number of additional cyber questions the user will have to answer is determined by subtracting the activity level from the current security level, with the number of additional Cyber questions returned as the security level in step 716 to the process illustrated in FIG. 6.

FIG. 8 shows steps 800 for how the PIN-number for the CyberKeyP system is determined. Step 802 shows the screen size, which determines the number of answers to display to the user, as an input parameter to this process. Step 804 determines the position of the right answer to every Cyber question by using a random number generator. Step 806 loops until the positions of all the answers to the Cyber questions have been determined. All the positions of the individual questions are combined into a unique PIN, step 808, which is different for each verification process. This PIN-number is then used in the process illustrated in FIG. 6, step 810.

FIG. 9 shows the process 900 of displaying question screens to the user. Step 902 shows screen size and the required security level as input parameters to this process. The position of the correct answer for every Cyber question has been determined in steps 800. Step 904 takes the entire PIN number and breaks it into the corresponding answer position for each question. For example, if the entire PIN had been “10080406” with four questions and a screen size of 16, then the PIN “10080406” would be divided into 10, 08, 04, and 06. These numbers represent that the correct answer for the first question would be in position 10 out of 16, the correct answer to the second question would be in position eight out of 16, the correct answer to the third question would be in position four out of 16, and finally the answer to the fourth question would be in position six out of 16. The positions 10, 08, 04, and 06 are generated using a random number generator.

A random number generator is an algorithm which generates a sequence of numbers in what appears to be a random order. There are many available random number generators, some available as libraries in programming languages. The choice of a random number generator can vary, however it is important to have a random number generator with high periods, which stands for the number of unique combinations which can be produced, and which would not allow an attacker to figure out the sequence of numbers produced by the random number generator.

In step 906, a Cyber question gets selected from the pool of questions the user has pre-answered during the initial enrollment or during subsequent question answering sessions to increase the security of the CyberKeyP system. This question gets selected randomly. Thus, CyberKeyP provides two degrees of randomness in the authentication process, one when creating the PIN which represents the positions of the correct answers, and two when picking a random question to be asked to the user. In step 908, the correct answer gets positioned according to the PIN number. The rest of the possible answers are filled with incorrect entries on the question screen, step 910.

As described in detail above, the manner in which incorrect entries are generated is also important. If a user is asked to name their favorite team and selects a correct answer that is nonsensical, and all of the other false answers are appropriate teams names, it might be possible for an unauthorized user to guess the correct answer by picking the one that does not make sense. Accordingly, each correct answer selected by a user must be analyzed before the false answers are generated. If the correct answer is nonsense, then one or more of the false answers must also be nonsense, and of a form that is similar to the nonsense correct answer. For example, if the user selected the name “water bottle” for their favorite team name, at least one false answer should be similar to the correct answer, such as “milk bottle”, or “can opener” or some other form of nonsense answer. If the user just typed in a series of random keys, such as “qwerty” for the correct answer, then at least one false answer should be similar, such as “asdfg”. The remaining false answers could be appropriate answers to the question. Many different programs could be used to generate the false answers as previously described, such as semantic systems or even human operators.

Step 912 checks to see if the user answered the current question correctly. If the user picked the correct answer, a one is added to the right answers counter, which keeps track of how many answers the user got right, step 914. This process gets repeated for the requested numbers of screens, step 916. The security level is reached when the user answers the number of questions equal to the security level, or an attempt threshold has been reached. For example, if the security level is four, then the user is required to answer four questions, with four question screens displayed to the user, and possibly up to two additional questions if one or two of the original four questions were answered incorrectly. If more than two questions were answered incorrectly, the user is given no additional questions. Step 918 returns the number of Cyber questions answered correctly by the user to the process illustrated in FIG. 6.

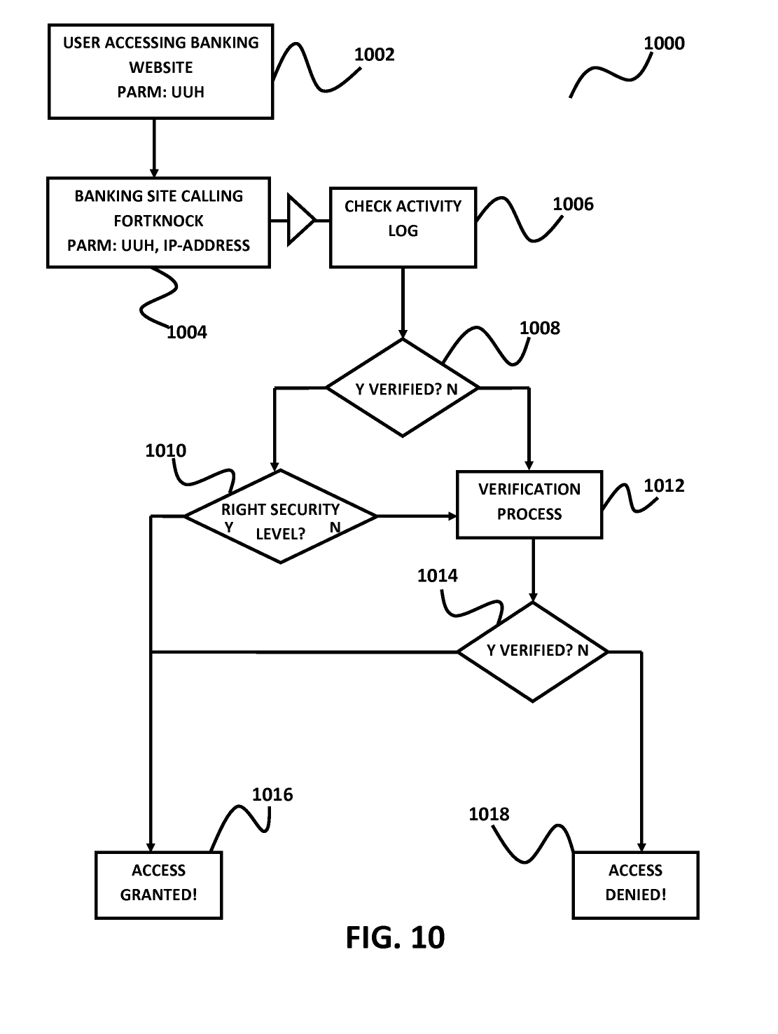

FIG. 10 shows how verification takes place with an example banking website once a user has enrolled both with the CyberKeyP system, the banking website, and the user has specified in the banking website that the CyberKeyP system is to be used for authentication. In step 1002, the user tries to access the example banking website. The website determines that the user is an enrolled member of the online banking services as well as CyberKeyP system user, and a request is made by the banking website in step 1004 for identify verification. The direct communication between the website and the CyberKeyP system is crucial to ensure maximum security. Step 1006 checks whether the user has been inactive for a prolonged period of time. Step 1008 determines whether the user has previously been verified, in which case step 1010 determines whether the security level required by the website has been met. If the right security level has been met, then access is granted in step 1016. If the user is not verified in step 1008, the user then must go through the verification process in step 1012. Depending on the information retrieved from the activity log in step 1006, the user may be required to answer additional questions. The additional verification processes take place in step 1012. The result of the verification process is checked in step 1014, with success resulting in access granted, step 1016, or access denied if the user fails to pass the verification process, step 1018.

While the present invention has been illustrated and described herein in terms of a preferred embodiment and several alternatives associated with various features, it is to be understood that the various components and features of the combination of elements described herein and the combination itself can have a multitude of different arrangements, uses and applications. For example, the electronic display console of an automobile could be programmed to ask a user a set of security questions in accordance with the invention before permitting the user to start the car, so as to verify an authorized driver's identity. Accordingly, the invention should not be limited to just the particular descriptions and various drawing figures contained in the specification that merely illustrate one or more preferred embodiments and applications of the principles of the invention.

What is claimed is:

1. A method of registering an entity for a single login authentication system, comprising the steps of:
(a) initiating a registration session for the entity on a computer system having a storage system;
(b) selecting a plurality of registration questions;
(c) presenting a set of registration questions from the plurality of registration questions to the entity;
(d) accepting a registration answer to at least one registration question among the set of registration questions; wherein the registration answer is created by the entity and can be either an accurate answer or an inaccurate answer to the at least one registration question;
(e) storing the registration answer in the storage system; and
(f) building an initial identity profile of the entity based on the registration answer.

2. The method as recited in claim 1, wherein steps (c) to (e) are repeated until a predetermined number of registration questions from the plurality of registration questions have been answered and stored in the storage system.

3. The method as recited in claim 2, wherein the computer system further has a display screen, further comprising the step of determining a size of the display screen, and wherein step (c) includes displaying all of the registration questions within the set of registration questions within the display screen.

4. The method as recited in claim 1, wherein each registration question among the plurality of registration questions is an opinion-based question.

5. The method as recited in claim 1, after the step of building an initial identity profile, further comprising the steps of:
(g) initiating a second registration session;
(h) presenting an additional set of registration questions from the plurality of registration questions to the entity, the additional set of registration questions excluding any registration questions already answered by the entity;
(i) repeating steps (d) and (e) for each registration answer generated by the entity based on the additional set of registration questions; and
(j) modifying the initial identity profile based on each registration answer to create a modified identity profile.

6. The method as recited in claim 5, further comprising the step of repeating steps (g) to (j) until a predetermined number of second registration questions from the additional set of registration questions have been answered and stored in the storage system.

7. The method as recited in claim 5, wherein the computer system further has a display screen, further comprising the step of determining a size of the display screen, and wherein step (h) includes displaying that additional set of registration questions within the display screen.

8. The method as recited in claim 5, wherein the additional set of registration questions are selected from the storage system using a random number generator.

9. The method as recited in claim 5, wherein the additional set of registration questions presented to the entity are selected from the storage system using a statistical analysis.

10. The method as recited in claim 5, wherein each registration answer is statistically compared to a plurality of registration answers from a plurality of other entities to determine a set of registration answer frequencies among a plurality of entities.

11. The method as recited in claim 1, wherein an identification label is used to uniquely identify the entity.

12. The method as recited in claim 1, wherein the set of registration questions are selected from the storage system using a random number generator.

13. The method as recited in claim 1, wherein the set of registration questions presented to the entity are selected from the storage system using a statistical analysis.

14. The method as recited in claim 1, wherein each registration answer is statistically compared to a plurality of registration answers from a plurality of other entities to determine a set of registration answer frequencies among a plurality of entities.

15. A method of verifying an identity of an entity for a single login authentication system that controls access to one or more secure systems, comprising the steps of:
(a) initiating a verification session for the entity within a computer system having a storage system;
(b) selecting a plurality of verification questions from the storage system;
(c) presenting a verification question from the plurality of verification questions to the entity;
(d) presenting a set of verification answers from a plurality of answers for the verification question, the set of verification answers including a correct verification answer and two or more incorrect verification answers;
(e) accepting a verification answer from the entity from among the set of verification answers;
(f) comparing the verification answer with the correct verification answer for a positive match;
(g) repeating steps (c) to (f) for a predetermined number of verification questions among the plurality of verification questions; and
(h) verifying the identity of the entity for the single login authentication system if the positive match for the predetermined number of verification questions has satisfied a threshold level.

16. The method as recited in claim 15, further including the steps of:
taking the plurality of verification questions from a set of registration questions selected by the entity during a registration session; and
taking the two or more incorrect verification answers from answers by two or more other users of the single login authentication system created during registration sessions by the two or more other users.

17. The method as recited in claim 16, further including the step of receiving the correct verification answer created by the entity during the registration session for a registration question among the set of registration questions.

18. The method as recited in claim 16, further including the step of uniquely identifying the entity through an identification label created during the registration to one or more secure systems that participate in the single login authentication system.

19. The method as recited in claim 16, further including the step of uniquely identifying the entity through an identity profile created during the registration session to one or more secure systems that participate in the single login authentication system.

20. The method as recited in claim 15, further including the steps of:
maintaining an activity level log representing the entity's use of the computer system; and
repeating steps (c) to (f) for at least one verification question among the plurality of verification questions based on the activity level log.
